(19) United States
(12) Patent Application Publication
(10) Pub. No.: US 2014/0339342 A1
(43) Pub. Date: Nov. 20, 2014

(54) INJECTOR FOR A SYSTEM FOR FEEDING GAS FUEL TO AN INTERNAL COMBUSTION ENGINE

(71) Applicant: Matrix S.p.A., Ivrea (IT)

(72) Inventors: Mario Gaiardo, Ivrea (IT); Piercarlo Barbero, Ivrea (IT)

(21) Appl. No.: 14/344,857

(22) PCT Filed: Sep. 14, 2012
(86) PCT No.: PCT/IB2012/054824

§ 371 Date: Aug. 1, 2014

(30) Foreign Application Priority Data
Sep. 14, 2011 (IT) TO2011A000821

(51) Int. Cl. F02M 69/04; F02M 51/06

(52) U.S. Cl. CPC F02M 69/042; F02M 51/061
USPC 239/585.1; 239/584

(57) ABSTRACT

An injector for a system for feeding gas fuel to an internal combustion engine has an inlet mouth for the fuel into the injector, houses therein a shutter which is moveable between a closed position and an open position of an outlet mouth of the fuel from the injector, and is defined by an inlet body provided with the inlet mouth and a first actuating device to displace the shutter in an open position thereof and at least two interchangeable outlet modules, each of which is adapted to be releasably fixed to the inlet module, and is provided with a relative outlet mouth, a relative shutter, and a relative second actuating device to displace the shutter in a closed position thereof.

### TECHNICAL FIELD

The present invention relates to an injector for a system for feeding gas fuel, e.g. GPL or methane, to an internal combustion engine.

### BACKGROUND ART

In the sector of systems for feeding gas fuel to an internal combustion engine, it is known to provide a system comprising a tank for containing a fuel in the liquefied gas state, a pressure reducer connected to the tank to reduce the fuel pressure, a feeding manifold connected to the pressure reducer, and a plurality of injectors connected in parallel to one another to the feeding manifold to selectively feed the fuel to the respective cylinders of the internal combustion engine.

The injector generally comprises a boxed body which is shaped so as to define an inlet mouth for the fuel into the injector and an outlet mouth for the fuel from said injector.

The boxed body houses therein a shutter which is mounted to be displaced between a closed position and an open position of the outlet mouth, an electromagnetic actuator to displace the shutter from the closed position thereof to the open position thereof, and an elastic thrust device to displace the shutter from the open position thereof to the closed position thereof.

The known systems for feeding gas fuel to an internal combustion engine of the above-described type are relatively costly and have a relatively low flexibility because they involve the provision and use of different types of injectors which are specifically provided as a function of the different types of feed manifolds and the different types of cylinders connected to said injectors.

### DISCLOSURE OF INVENTION

The object of the present invention is to provide an injector for a system for feeding a gas fuel to an internal combustion engine which is free from the above-described drawbacks and simple and cost-effective to be implemented.

According to the present invention, an injector is provided for a system for feeding gas fuel to an internal combustion engine, the injector comprising an inlet mouth for the fuel into the injector; an outlet mouth of the fuel from the injector; and a valve device, which is arranged between the inlet mouth and the outlet mouth, and comprises, in turn, a shutter, a first actuating device to displace the shutter in an open position, in which the inlet mouth and the outlet mouth are connected to one another to allow the feeding of fuel to the outlet mouth, and a second actuating device to displace the shutter in a closed position, in which the inlet mouth and the outlet mouth are separate from one another to prevent the feeding of the fuel to the outlet mouth; and being characterised also by comprising an inlet module provided with the inlet mouth and with the first actuating device; at least two interchangeable outlet modules, each of which is provided with said relative outlet mouth, with said relative shutter, and with said relative second actuating device; and locking means to releasably lock the outlet modules on the inlet module.

### BRIEF DESCRIPTION OF THE DRAWINGS

The present invention will now be described with reference to the accompanying drawings, which illustrate an embodiment thereof by way of non-limiting example, in which:

FIG. 1 is a diagrammatic, perspective view of a preferred embodiment of the injector of the present invention;

FIG. 2 is a diagrammatic, perspective view of the injector in FIG. 1 mounted in a system for feeding a gas fuel to an internal combustion engine;

FIG. 3 is a diagrammatic view in section, with parts removed for clarity, of a detail of FIG. 2;

FIG. 4 is a diagrammatic, perspective view of a first variation of the injector in FIG. 1;

FIG. 5 is a diagrammatic, perspective view of a second variation of the injector in FIG. 1; and

FIG. 6 is a diagrammatic view in section of the injector in FIG. 5.

### BEST MODE FOR CARRYING OUT THE INVENTION

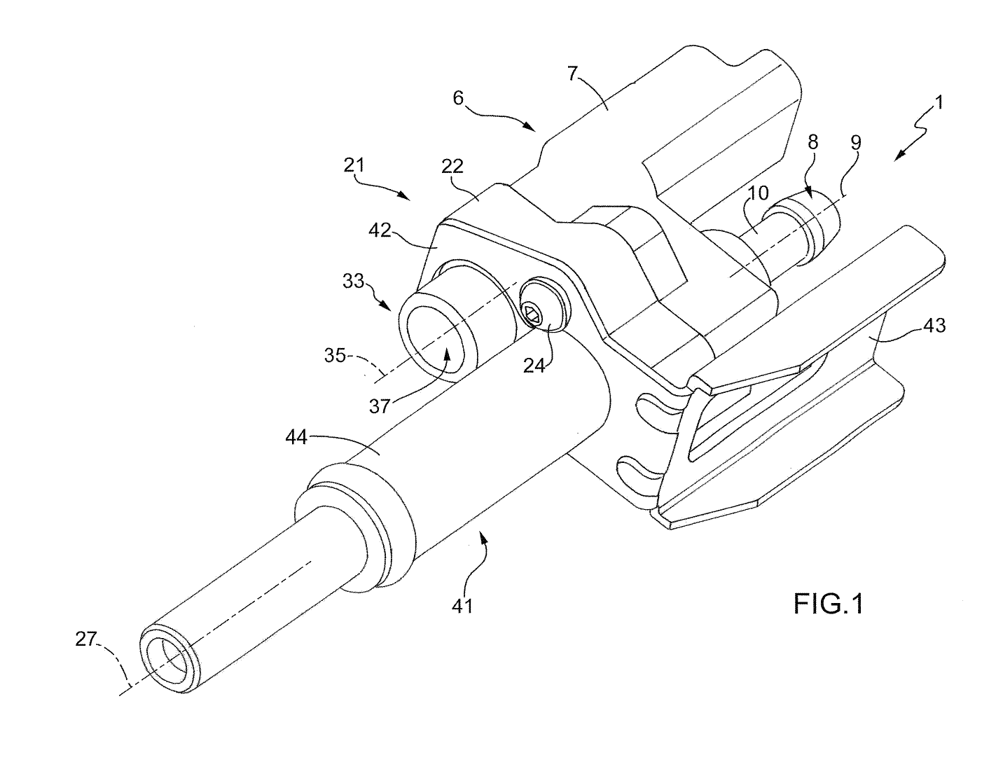

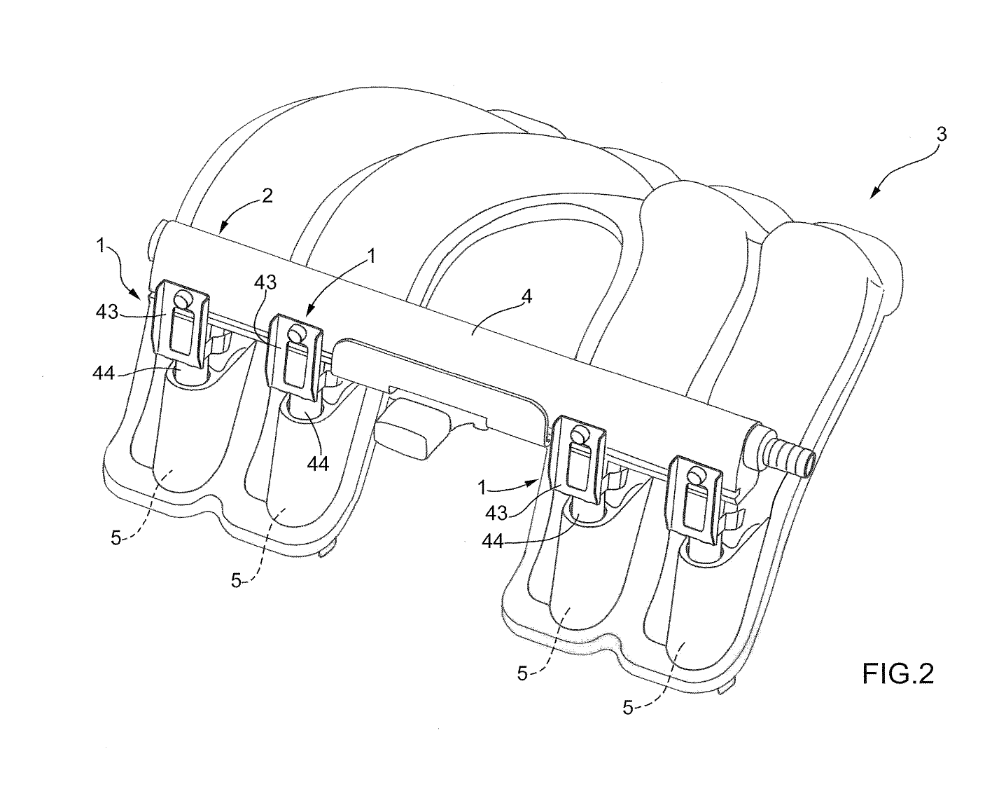

With reference to FIGS. 1, 2, and 3, the numeral 1 indicates, as a whole, an injector used in a system 2 for feeding a gas fuel, e.g. GPL or methane, to an internal combustion engine 3.

System 2 comprises a tank (not shown) for containing a fuel in liquefied gas form, a pressure reducer (not shown) connected to the tank (not shown) to reduce the fuel pressure and determine, in the case of GPL, the passing to the gas state, a tubular feeding manifold 4 connected to the pressure reducer (not shown), and a plurality of injectors 1 connected in parallel to one another to manifold 4 to selectively feed the gas fuel to respective cylinders 5 of internal combustion engine 3.

It is appropriate to specify that in the following description, the term “cylinder” means the group of the fuel injection cylinder and the possible feeding pipe interposed between injector 1 and said injection cylinder. Each injector 1 has an inlet module 6 comprising a boxed body 7 shaped so as to define an inlet mouth 8, which has a longitudinal axis 9, and comprises an inlet segment 10 protruding within manifold 4 to allow the gas fuel to enter injector 1 and an outlet segment 11 protruding within a substantially rectangular-shaped cavity 12 obtained in the boxed body 7.

Cavity 12 opens outwards at an end face 13 of boxed body 7 which is substantially flat and perpendicular to axis 9, and is limited by a bottom wall 14 which is substantially perpendicular to axis 9 and a lateral wall 15 which is substantially parallel to said axis 9.

Cavity 12 houses therein an actuating device 16 defined by an electromagnetic actuator 17 comprising a cup-like body 18 inserted in cavity 12 so as to extend about segment 11, a core 19 made of magnetic material mounted in body 18, and a coil 20, which is wound about core 19, and is electrically fed by a known control unit (not shown).

Cavity 12 is closed by an outlet module 21 of injector 1 comprising a boxed body 22, which is limited by a substantially flat end face 23 arranged in contact with face 13, is releasably fixed to boxed body 7 by means of a pair of locking screws 24 parallel to axis 9, and has a cavity 25, which opens outwards at face 23, and faces cavity 12.

Boxed body 22 is shaped so as to define an outlet mouth 26, which has a longitudinal axis 27 parallel to axis 9, protrudes from boxed body 22 opposite face 23, and has an inlet hole 28 facing cavity 25.

Cavity 25 houses therein a shutter 29 comprising a plate 30, which is made of magnetic material, faces actuator 17, and is provided with a closing disc 31 made of elastomeric material facing hole 28.

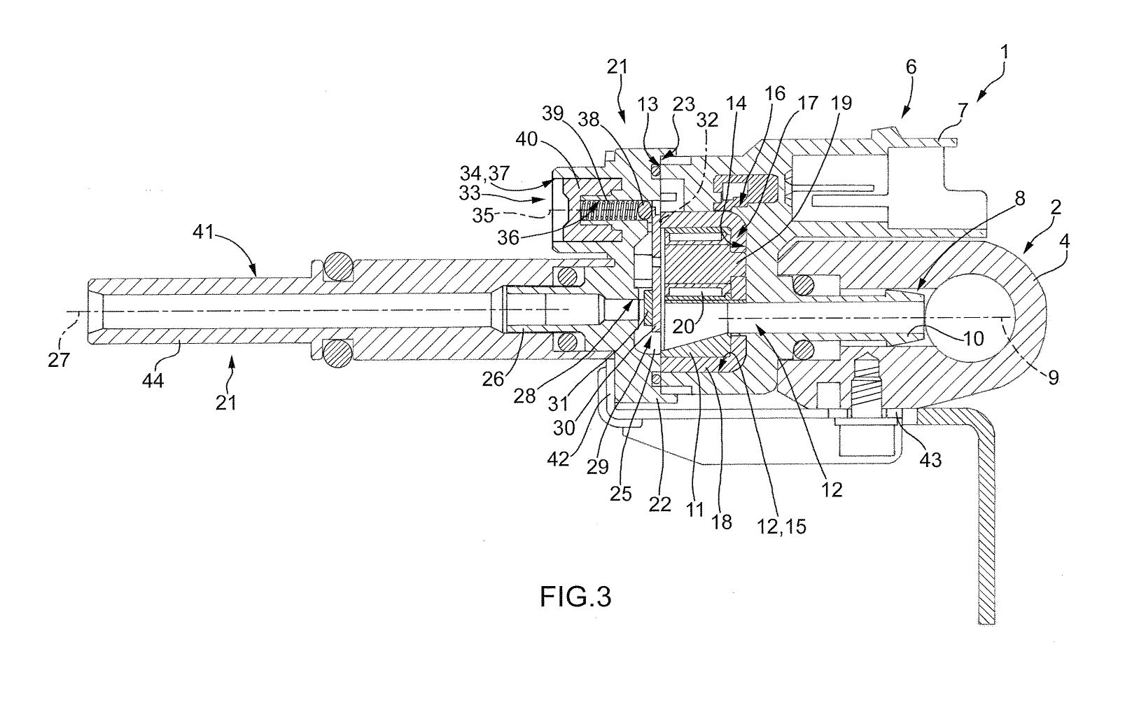

Plate 30 is mounted to rotate, with respect to boxed body 22, about a rotation axis 32 obtained on the free face of body 18 transverse to axis 9 between an open position (FIG. 3), in which plate 30 is arranged parallel to faces 13, 23 to allow disc 31 to disengage hole 28 and the gas fuel to flow through mouth 26 and the relative cylinder 5, and a closed position (not shown), in which plate 30 is inclined with respect to axis 9 to allow disc 31 to close hole 28 and the gas fuel to flow through mouth 26 and, therefore, the relative cylinder 5.

When the electricity feed of coil 20 is interrupted, plate 30 is displaced, and normally maintained in the closed position thereof by an elastic thrust device 33, which defines, together with actuating device 16 and shutter 29, a valve adapted to selectively control the feeding of gas fuel to the relative cylinder 5.

Device 33 is housed in outlet module 21, and comprises a through hole 34, which is obtained through boxed body 22, has a longitudinal axis 35 which is parallel to axis 9, and comprises a narrowed portion 36 and a widened portion 37 which are substantially coaxial to one another.

Portion 36 houses therein a bar 38 made of elastomeric material, which is arranged with a longitudinal axis thereof parallel to axis 32, and is maintained in contact with an end of plate 30 by a spring 39, which is mounted within portion 36 coaxially to axis 35, and is arranged between bar 38 and an adjusting nut 40 screwed into portion 37 to selectively pre-load said spring 39.

When coil 20 is electrically fed, plate 30 is displaced in the open position thereof against the action of spring 39 by actuator 17, which exerts a rotation torque on plate 30 which is opposite and in any case greater than the rotation torque exerted on plate 30 by said spring 39.

The outlet module 21 further comprises a coupling block 41 of injector 1 with manifold 4 and with the relative cylinder 5.

Block 41 comprises a plate 42, which is arranged perpendicularly to axis 9, is releasably fixed to boxed body 22 by means of the screws 24, and is bent according to an angle of substantially 90° so as to define a hooking bracket 43 of injector 1 to manifold 4.

Plate 42 is further provided with a coupling joint 44, which extends coaxially to axis 27, is fluid-tightly coupled with mouth 26, and protrudes from plate 42 opposite boxed body 22 to be fluid-tightly coupled within the relative cylinder 5.

With regard to what is described above, it is appropriate to specify that outlet module 21 is provided with at least two interchangeable coupling blocks 41, which are releasably fixed to boxed body 22 by means of the screws 24, and differ from one another due to different diameters and/or lengths of the joints 44.

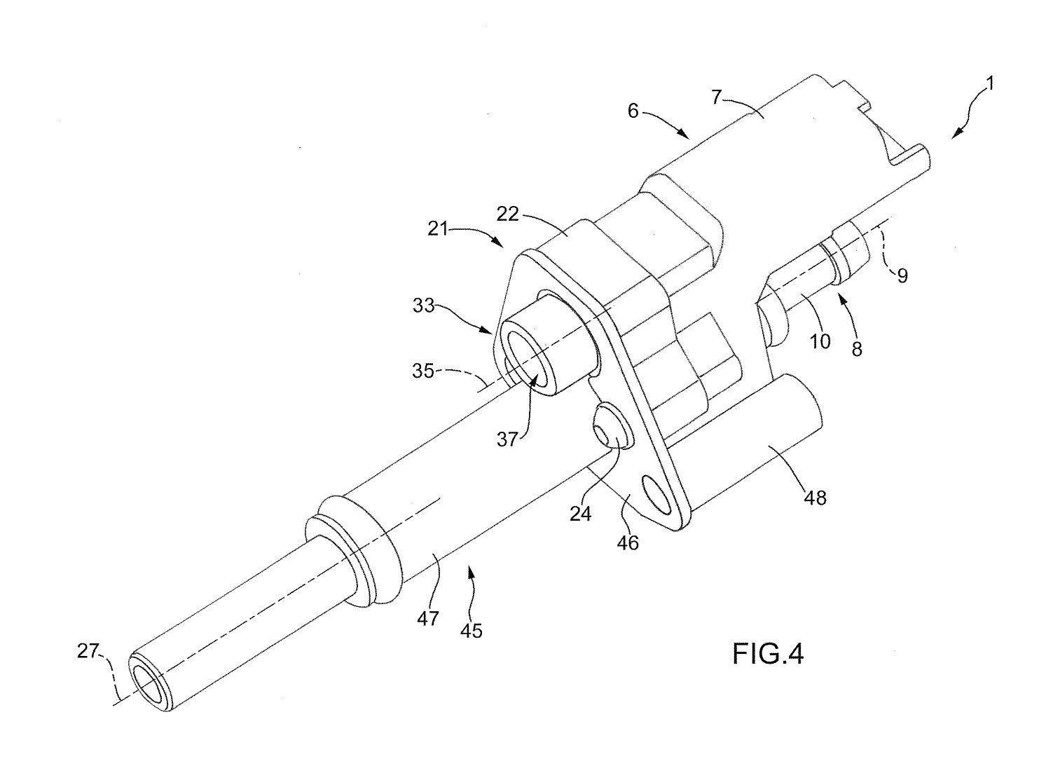

The variation in FIG. 4 differs from what is shown in the preceding figures solely in that block 41 is eliminated and replaced with a coupling block 45 comprising a plate 46, which is arranged perpendicularly to axis 9, is releasably fixed to boxed body 22 by means of the screws 24, and is provided with a coupling joint 47 which is completely like joint 44.

Block 45 is hooked to manifold 4 by means of two bushes 48 which are parallel to one another, which protrude from plate 46 opposite joint 7 and the two boxed bodies 7, 22, extend parallel to axis 9, and are engaged by respective fixing members (not shown) adapted to releasably lock block 45 on manifold 4.

Also in this case, the outlet module 21 is provided with at least two interchangeable coupling blocks 45, which are releasably fixed to the boxed body 22 by means of the screws 24, and differ from one another due to different diameters and/or lengths of the joints 47 and/or the bushes 48.

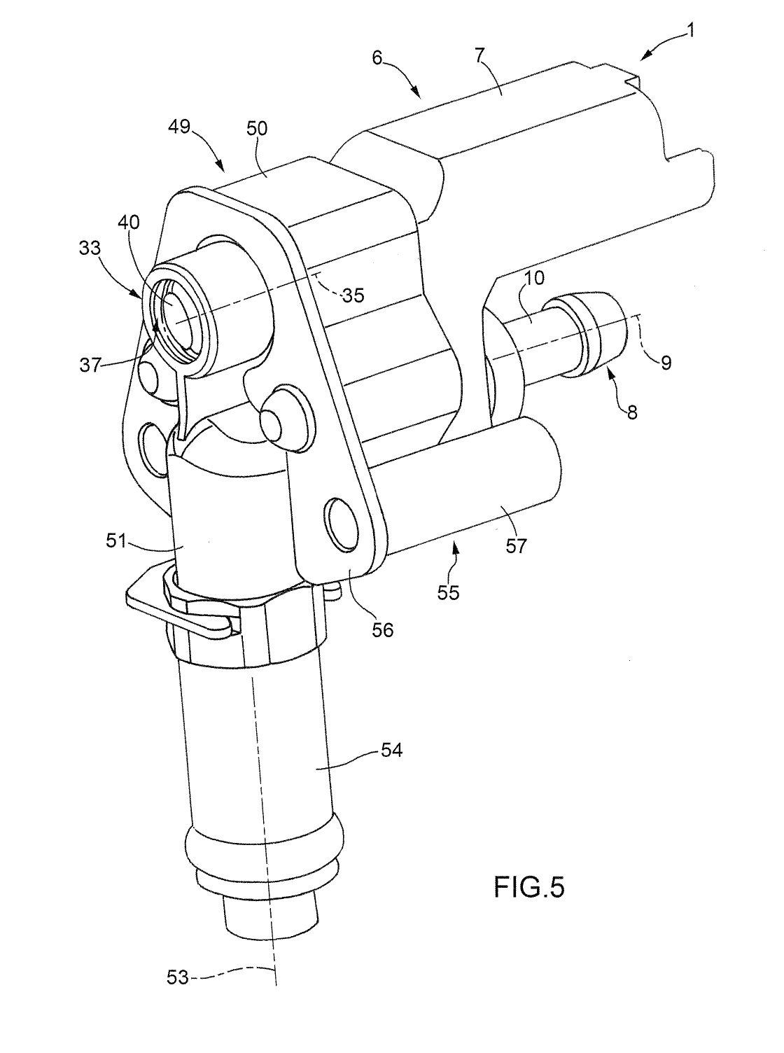

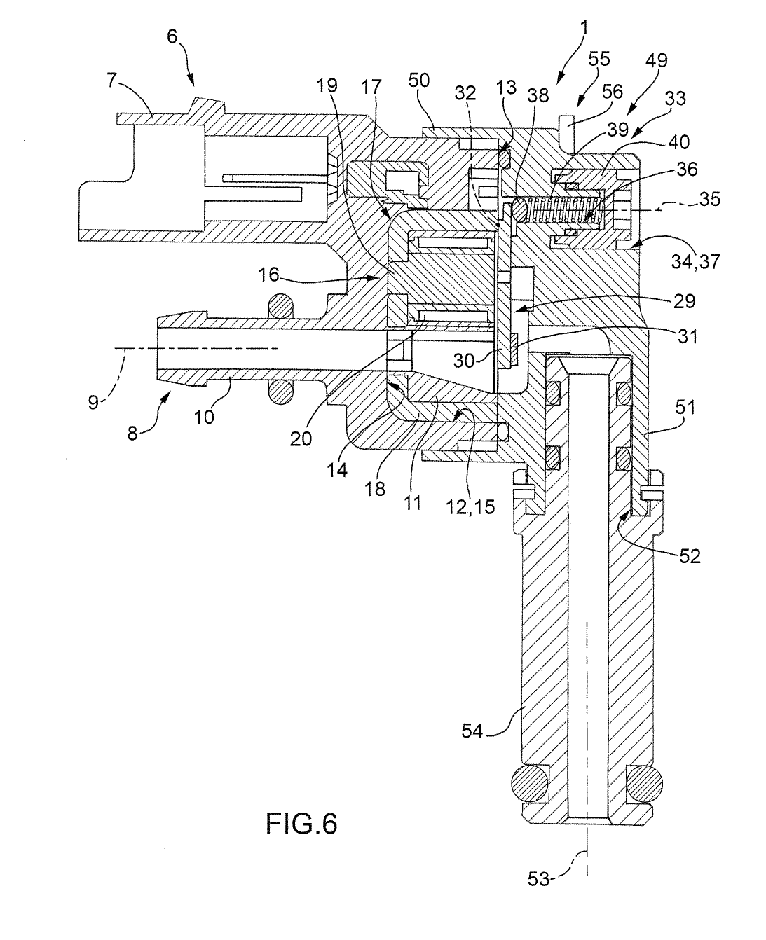

The variation in FIGS. 5 and 6 differs from what is shown in the preceding figures in that outlet module 21 is eliminated and replaced with an outlet module 49 comprising a boxed body 50, which is like the boxed body 22, and differs from the latter in that it has an outlet mouth 51 comprising an outlet segment 52 having a longitudinal axis 53 transversal to axis 9.

The outlet module 49 is further provided with a plurality of interchangeable coupling joints 54 adapted to be fluid-tightly coupled with segment 53 and allow the coupling of injector 1 with the relative cylinder 5, and has a plurality of interchangeable coupling blocks 55, which are releasably fixed to the boxed body 22 by means of the screws 24, and each comprise a respective plate 56 like plate 46 and a respective pair of bushes 57, which are like the bushes 48, and differ from the bushes 57 of the other blocks 55 due to diameter and/or length.

From what is described above, it follows that the interchangeability of the different outlet modules 21 and 49, the different coupling blocks 41, the different coupling blocks 45, the different coupling joints 54, and the different coupling blocks 55 allows different configurations of injector 1 with the same inlet module 6, and therefore allows to at least partly standardize the components of injector 1, reduce the production costs of injector 1, and increase the flexibility of said injector 1.

1. An injector for a system (2) for feeding gas fuel to an internal combustion engine (3), the injector comprising an inlet mouth (8) for the fuel into the injector; an outlet mouth (26; 51) of the fuel from the injector; and a valve device, which is arranged between the inlet mouth (8) and the outlet mouth (26; 51), and comprises, in turn, a shutter (29), a first actuating device (16) to displace the shutter (29) in an open position, in which the inlet mouth (8) and the outlet mouth (26; 51) are connected to one another to allow the feeding of fuel to the outlet mouth (26; 51), and a second actuating device (33) to displace the shutter (29) in a closed position, in which the inlet mouth (8) and the outlet mouth (26; 51) are separate from one another to prevent the feeding of the fuel to the outlet mouth (26; 51); the injector also comprising an inlet module (6) provided with the inlet mouth (8) and with the first actuating device (16); at least two interchangeable outlet modules (21; 49), each of which is provided with said relative outlet mouth (26; 51), with said relative shutter (29), and with said relative second actuating device (33); and locking means (24) to releasably lock the outlet modules (21; 49) on the inlet module (6);
characterized in that the inlet mouth (8) has a first longitudinal axis (9); in that the outlet mouth (51) of a second said outlet module (49) having, at least at an outlet segment (52) thereof, a second longitudinal axis (53) transversal to the first axis (9); and in that the outlet mouth (26) of a second said outlet module (21) has a third longitudinal axis (27) parallel to the first axis (9).

2. The injector according to claim 1, wherein the inlet module (6) comprises a first boxed body (7), which has the inlet mouth (8) , and houses therein the first actuating device (16) , and wherein each outlet module (21; 49) comprises a second boxed body (22; 50), which has the relative outlet mouth (26; 51), houses therein the relative shutter (29) and the relative second actuating device (33), and is releasably locked on the first boxed body (7).

3. The injector according to claim 2, wherein at least one of the outlet modules (21; 49) also comprises at least two interchangeable hooking blocks (41; 45; 55), each of which is adapted to be releasably fixed to the second boxed body (22; 50), and allows the hooking of the injector to a fuel feeding manifold (4) to the inlet mouths (8) of a plurality of injectors.

4. The injector according to claim 3, wherein each hooking block (41; 45; 55) comprises a fastening plate (42; 46; 56) releasably fixed to the second boxed body (22; 50) perpendicularly to a longitudinal axis (9) of the inlet mouth (8).

5. The injector according to claim 4, wherein the hooking block (45; 55) has a pair of bushes (48;57) , which protrude from the fastening plate (46; 56) parallel to the longitudinal axis (9) of the inlet mouth (8) to allow the hooking of the injector to the feeding manifold (4).

6. The injector according to claim 4, wherein the fastening plate (42) is substantially L-shaped to define a hooking bracket (43) of the injector to the feeding manifold (4).

7. The injector according to claim 2, wherein at least one of the outlet modules (21; 49) also comprises at least two interchangeable coupling joints (44; 47; 54), each of which is adapted to be releasably fixed to the second boxed body (22; 50) coaxially to the outlet mouth (26; 51) to couple the injector with a cylinder (5) of said internal combustion engine (3).

8. The injector according to claim 7, wherein the coupling joints (44; 47; 54) have lengths and/or diameters which differ from one another.

9. The injector according to claim 7, wherein the coupling joints (44; 47) protrude from the fastening plate (42; 46) parallel to a longitudinal axis (27) of the outlet mouth (26).

10. The injector according to claim 1, wherein the first actuating device (16) comprises an electromagnetic actuator (17) housed in the inlet module (6) to displace the shutter (29) from its open position to its closed position and wherein the second actuating device (33) comprises an elastic thrust system (38, 39) housed in the relative outlet module (21; 49) to displace the shutter (29) from its open position to its closed position.

11-12. (canceled)
